(19) United States
(12) Patent Application Publication
(10) Pub. No.: US 2006/0268141 A1
(43) Pub. Date: Nov. 30, 2006

(54) Method for driving solid-state imaging device and solid-state imaging device

(75) Inventors: Makoto Kobayashi, Kurokawa-gun (JP); Katsumi Ikeda, Kurokawa-gun (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/434,240

(22) Filed: May 16, 2006

(30) Foreign Application Priority Data
May 18, 2005 (JP) P2005-145798

(51) Int. Cl. H04N 5/335

(52) U.S. Cl. 348/311

(57) ABSTRACT

A method for driving a solid-state imaging element, which includes photoelectric conversion parts; vertical charge-transfer paths transferring signal charges from the photoelectric conversion parts in the vertical direction, each of the vertical charge-transfer paths including pairs of a first and second electrodes; and a horizontal charge-transfer path transferring the signal charge in a horizontal direction, is provided and includes applying driving pulses to the first and second electrodes to transfer the signal charge in the vertical direction. The transferring of the signal charge in the vertical charge-transfer paths is performed in such a way that when the signal charge is transferred from an electrode whose length is longer, a charge transfer time is lengthened, and that when the signal charge is transferred from an electrode whose length is shorter, a charge transfer time is shortened.

### FIELD OF THE INVENTION

The present invention relates to a method for driving a solid-state imaging element and a solid-state imaging device.

### BACKGROUND OF THE INVENTION

A structure of a solid-state imaging device is described by referring to FIG. 1. A solid-state imaging device 100 having a solid-state imaging element such as a CCD includes a solid-state imaging element 150 and an element driving part 170 for inputting a driving signal to the solid-state imaging element 150. The solid-state imaging element 150 is driven and controlled in accordance with an output signal from the element driving part 170.

The solid-state imaging element 150 includes a plurality of photodiodes (photoelectric conversion parts) 11 arranged two-dimensionally, a plurality of rows of vertical shift registers (hereinafter, sometimes refer to as vertical charge transfer paths) 13 for reading signal charges generated in the photodiodes 11 in the direction of rows of the arrangement of the photodiodes 11 and sequentially transferring the signal charges in the direction of rows, a horizontal shift register (hereinafter, sometimes refer to as a horizontal charge transfer path) 15 arranged at the end parts of the vertical shift registers 13 to transfer the signal charges from each of the vertical shift registers 13 in the horizontal direction and an output amplifier 17 arranged in an end side in the charge transferring direction of the horizontal shift register 15, converting the transferred signals to voltage values and outputting the converted signals. The above-described solid-state imaging element 150 is ordinarily referred to as a charge coupled device (CCD) and controlled by a below-described driving waveform.

FIG. 5 shows an ordinary driving wave form of the solid-state imaging element. During a reading period T_{R} of the signal charge, the signal charge generated in the photodiode 11 is read to the vertical shift register 13 by applying V_{H} to an electrode of a reading gate 19. The electrode of the reading gate 19 also serves as a driving electrode of the vertical shift register 13. During a transfer period T_{T} of the signal charge, pulses of an intermediate potential V_{M} and a low potential V_{L} are sequentially applied to the driving electrode to carry out a transfer operation of the signal charge to the horizontal shift register 15. During the transfer period T_{T}, the horizontal transfer operation of the horizontal shift register 15 is carried out in the intervals of the transfer operations of the vertical shift register 13. This horizontal driving operation employs a well-known two phase driving operation by HM and HL pulses as shown in the drawing. Thus, an output source signal OS corresponding to a quantity of received light of the photodiode 11 is outputted from the output amplifier 17.

Now, a specific structural example of the solid-state imaging element 150 will be described below.

FIG. 6 is a schematic plan view of the solid-state imaging element (the width or the arrangement of the illustrated electrodes are merely schematically shown and have parts that do not necessarily correspond to those of an actual element structure). FIG. 7 is a schematic view of a structure of a section taken along a line A₁ to A₂ shown in FIG. 6. FIG. 8 is a schematic view of a structure of a section taken along a line B₁-B₂ shown in FIG. 6. FIG. 9 is a schematic view of a potential distribution in a section taken along a line C₁ to C₂ shown in FIG. 7.

As shown in FIGS. 6 to 8, in this structural example, the vertical shift register 13 that serves to transfer the signal charges in the same row for the photodiodes 11 of the same row in the vertical direction includes two electrodes. That is, the vertical shift register 13 is formed by arranging a plurality of pairs of first electrodes 21 and second electrodes 23 on the upper part of an n type impurity layer 25 along the transferring direction of the signal charges.

Further, element separate bands 27 are formed so as to define the areas of the adjacent photodiodes 11.

In the structure of the A₁-A₂ section shown in FIG. 7, a p type impurity well layer 43 is formed on the surface of an n type silicon substrate 41 and an insulating layer 45 including an SiN/SiO₂/SiN film (ONO film) is further formed thereon. Further, from the surface of the impurity well layer 43, a p type impurity layer 47 of high concentration is formed and an n type impurity layer 49 is formed in the lower part thereof Thus, the photodiode 11 is formed.

The above-described n type impurity layer 25 is formed in the side part of the reading gate 19 held between the photodiode 11 and the n type impurity layer 25. In the lower part of the n type impurity layer 25, a p type impurity layer 51 of high concentration is formed. On the surface of the insulating layer 45 above the n type impurity layer 25, the second electrode 23 is formed. The second electrode 23 is covered with an insulating layer 53.

Further, the element separate band 27 including a p type impurity layer of a high concentration is formed so as to surround one pixel area including the photodiode 11 and the n type impurity layer 25 serving as the vertical electric charge transfer path.

The plurality of the second electrodes 23 are formed along the vertical electric charge transfer path and the structure of the section thereof is shown in FIG. 8.

Here, a sufficiently high voltage (VH) is applied to the second electrode 23 (φV1 or φV3) shown in FIG. 6, a barrier 57 to the vertical shift register 13 is removed relative to the potential of the photodiode 11 so that all the accumulated signal charges D are completely moved to the shift register 13. That is, this state means that the photodiode 11 is completely depleted. In a case where the photodiode 11 is not completely depleted during reading the signal charge, for instance, when a reading operation and the transfer operation are continuously repeated as in a movie operation, the signal charge remaining in the photodiode 11 is superimposed on the signal charge accumulated until a next reading operation to cause what is called an after image phenomenon and a serious deterioration of a movie image. Accordingly, during reading the signal charge, voltage (minimum voltage is referred to as “minimum depletion voltage”) sufficient to completely deplete the photodiode 11 needs to be applied.

On the other hand, when pixels are made to be fine, efforts are made to shorten the length of the electrodes (La and Lb shown in FIGS. 6 and 8). However, when the second electrode 23 as a reading electrode is shortened, if the voltage V_{H} is applied during reading a signal from the photodiode 11, a gentle potential gradient arises due to a peripheral fringing electric field resulting from a fact that the potential of the adjacent electrode (the first electrode 21) or the element separate band 27 is low. Thus, the potential is lower than that of a case when the electrode is sufficiently long. Namely, this indicates a narrow channel effect. Accordingly, to obtain a desired potential, a higher voltage needs to be applied. As a result, a problem arises that a minimum driving voltage is caused to rise. To cope with this problem, the length Lb of the second electrode is made to be longer than the length La of the first electrode (Lb>La) to increase a reading area. Thus, the narrow channel effect is mitigated to suppress the depletion voltage of the photodiode to a low level.

As another examples for controlling the transfer of the electric charge of the vertical shift register in the solid-state imaging element as described above, for instance, JP-A-11-355663 and JP-A-2004-328314 may be exemplified.

However, as shown in FIG. 6 and FIG. 8, when the electrode length Lb of the second electrode 23 serving as the reading electrode in the transferring direction of the electric charge is made to be different from the electrode length La of other electrode (the first electrode 21) and Lb is longer than La, the signal charges are not completely transferred owing to the following two reasons.
(1) Since the fringing electric field of the adjacent electrode is weakened, the moving speed of the signal charge is lowered.
(2) Since a distance that the signal charge needs to move under the reading electrode is lengthened, it takes more time to move the signal charge under the reading electrode than under other electrode.

Consequently, the signal charges are not completely transferred under the reading electrode and a part of electric charges remain. The remaining signal charges are observed as vertical lines on a screen, so that the image is terribly deteriorated.

Now, the above-described phenomenon will be described below.

FIG. 10 shows a driving timing chart of the vertical electric charge transfer path. FIG. 11 shows a conceptual diagram of a potential distribution of the transfer path in the section taken along B₁-B₂ in FIG. 6.

Four types of vertical driving pulses φV1, φV2, φV3 and φV4 are applied to the transfer electrodes (the first electrode 21, the second electrode 23) of the vertical electric charge transfer path from a driver 33 (see FIG. 1) of the element driving part 170. Herein, the four-phase vertical driving pulses respectively take binary values of a high level (VM) and a low level (VL). The transfer of the signal charge of one line is carried out within a vertical transfer cycle including periods of t1 to t8.

In a period t0 before the start of the vertical transferring operation, since φV2 and φV3 are in the high levels (VM), as shown in FIG. 11, a deep potential well is formed under electrodes V2 and V3. Then, the signal charges are accumulated in the potential well and the signal charges shift to the vertical transfer cycle (t1 to t8) under this state.

That is, during the period t1, when φV4 becomes the high level, since the deep potential well extends over electrodes V2, V3 and V4, the signal charges are accumulated under the electrodes V2, V3 and V4.

Then, during the period t2, when φV2 becomes the low level, since the potential well under the electrode V2 is shallow, the signal charges are accumulated under the electrodes V3 and V4. At this time, under the electrode V2, the signal charge D is transferred to the electrodes V3 and V4.

Then, during the period t3, φV1 becomes the high level and the potential well under an electrode V1 is deep. Further, during the period t4, φV3 becomes the low level and the potential well under the electrode V3 is shallow. Thus, a shallow area of the potential well is formed from the electrode V2 to the electrode V3, so that the inclination of the potential is mitigated to lower the moving speed of the signal charges. Therefore, a part of the accumulated signal charges may sometimes remain under the electrode V3.

Then, during the period t5, φV2 becomes the high level and the shallow area of the potential well is reduced. At this time, the signal charges D remaining under the electrode V3 are relatively slowly transferred to flow out to the potential well including the lower part of the electrode V4. However, during the period t6, when φV4 becomes the low level, the transfer of the remaining signal charges D may sometimes stop to remain under the electrode V3. Under this state, during the period t7, when φV3 is made to become the high level, the signal charges do not return to a deep area 61 of the potential well in which the signal charges are to be originally accumulated and are superimposed on a deep area 63 of other adjacent potential well. The signal charges D remaining in the area 63 form left electric charges that cause the image to be deteriorated.

During the period t8, when φV1 is made to become the low level, the same situation as that of the period t4 arises so that the signal charges are repeatedly left. As described above, assuming that a period after the driving pulse of the low level is applied to the second electrode 23 serving as the reading electrode until the driving pulse of the low level is applied to the adjacent first electrode 21 is T, this period T is always constant in the vertical transfer cycle.

### SUMMARY OF THE INVENTION

An object of an illustrative, non-limiting embodiment of the invention is to provide a method for driving a solid-state imaging element and a solid-state imaging device in which even when the length of a reading electrode for reading a signal charge from a photoelectric conversion part relative to an charge transferring direction is longer than that of other electrode, the signal charges can be completely transferred without leaving them.

The above-described object can be achieved by below-described means.
(1) A method for driving a solid-state imaging element,

the solid-state imaging element comprising:

a plurality of photoelectric conversion parts arranged two-dimensionally in a horizontal direction and a vertical direction, each of the photoelectric conversion parts converting incident light to a signal charge;

a plurality of vertical charge-transfer paths, each transferring the signal charge, which is generated in the photoelectric conversion parts, in the vertical direction, wherein each of the vertical charge-transfer paths comprises a plurality of pairs of a first electrode reading out the electric charge from one of the photoelectric conversion parts and a second electrode arranged adjacently to the first electrode along the vertical direction, and the first and second electrodes have different lengths from each other in the vertical direction; and

a horizontal charge-transfer path transferring the signal charge, which is transferred from each of the vertical charge-transfer paths, in the horizontal direction,

the method comprising applying driving pulses to the first and second electrodes to transfer the signal charge, which is read out from the photoelectric conversion parts, in the vertical direction,

wherein the transferring of the signal charge in the vertical charge-transfer paths is performed in such a way that when the signal charge is transferred from one of the first and second electrodes, whose length is relatively long, to the other of the first and second electrodes, a charge transfer time is lengthened, and that when the signal charge is transferred from one of the first and second electrodes, whose length is relatively short, to the other of the first and second electrodes, a charge transfer time is shortened.

In the method for driving the solid-state imaging element, when a signal charge is transferred from the electrode whose length is relatively long to the electrodes whose length is relatively short, the charge transfer time is lengthened, and when a signal charge is transferred from the electrode whose length is relatively short to the electrodes whose length is relatively long, the charge transfer time is shortened. Accordingly, even when the gradient of a potential of an electric field is gentle, the transfer of the electric charges can be assuredly completed and remaining electric charges can be eliminated. Further, the charge transfer time from the electrodes whose electric charge transfer speed is high is shortened, so that the driving cycle of the solid-state imaging element is not delayed.
(2) A solid-state imaging device comprising:

a solid-state imaging element comprising:

a plurality of photoelectric conversion parts arranged two-dimensionally in a horizontal direction and a vertical direction, each of the photoelectric conversion parts converting incident light to a signal charge;

a plurality of vertical charge-transfer paths, each transferring the signal charge, which is generated in the photoelectric conversion parts, in the vertical direction, wherein each of the vertical charge-transfer paths comprises a plurality of pairs of a first electrode reading out the electric charge from one of the photoelectric conversion parts and a second electrode arranged adjacently to the first electrode along the vertical direction, and the first and second electrodes have different lengths from each other in the vertical direction; and

a horizontal charge-transfer path transferring the signal charge, which is transferred from each of the vertical charge-transfer paths, in the horizontal direction, and

an element-driving part driving and controlling the solid-state imaging element in such a way that when the signal charge is transferred from one of the first and second electrodes, whose length is relatively long, to the other of the first and second electrodes, a charge transfer time is lengthened, and that when the signal charge is transferred from one of the first and second electrodes, whose length is relatively short, to the other of the first and second electrodes, a charge transfer time is shortened.

In the solid-state imaging device, even when the gradient of a potential of an electric field is gentle, the transfer of the electric charges can be assuredly completed and remaining electric charges can be eliminated under the control of the element driving part. Further, the charge transfer time from the electrodes whose electric charge transfer speed is high is shortened, so that the driving cycle of the solid-state imaging element is not delayed.

In the method for driving the solid-state imaging element and the solid-state imaging device according to an exemplary embodiment of the present invention, even when the length of the reading electrodes for reading the signal charges from the photoelectric conversion parts relative to the charge transferring direction is longer than that of other electrodes, the signal charges can be completely transferred without leaving them.

### BRIEF DESCRIPTION OF TME DRAWINGS

FIG. 1 is a plan schematic view of a solid imaging element according to an exemplary embodiment of the present invention.

FIG. 2 is a driving timing chart of a vertical electric charge transfer path.

FIG. 3 is a conceptual diagram of a potential distribution in a section taken along a line B₁-B₂ of FIG. 6.

FIG. 4 is a sectional view taken along a line B₁-B₂ of FIG. 6 and an explanatory view showing another structural example of first electrodes and second electrodes.

FIG. 5 is an explanatory view showing a driving wave form of a solid-state imaging element in the related art.

FIG. 6 is a schematic plan view of a solid-state imaging element according to an exemplary embodiment of the present invention and the related art.

FIG. 7 is a schematic view of a structure of a section taken along a line A₁ to A₂ shown in FIG. 6.

FIG. 8 is a schematic view of a structure of a section taken along a line B₁-B₂ shown in FIG. 6.

FIG. 9 is a schematic diagram of a potential distribution in a section taken along a line C₁-C₂ shown in FIG. 7.

FIG. 10 is a driving timing chart of a usual vertical electric charge transfer path.

FIG. 11 is a conceptual diagram of a potential distribution in a section taken along a line B₁-B₂ of FIG. 6.

### DETAILED DESCRIPTION OF THE INVENTION

Now, an exemplary embodiment of a method for driving a solid-state imaging element and a solid-state imaging device will be described below in detail by referring to the drawings.

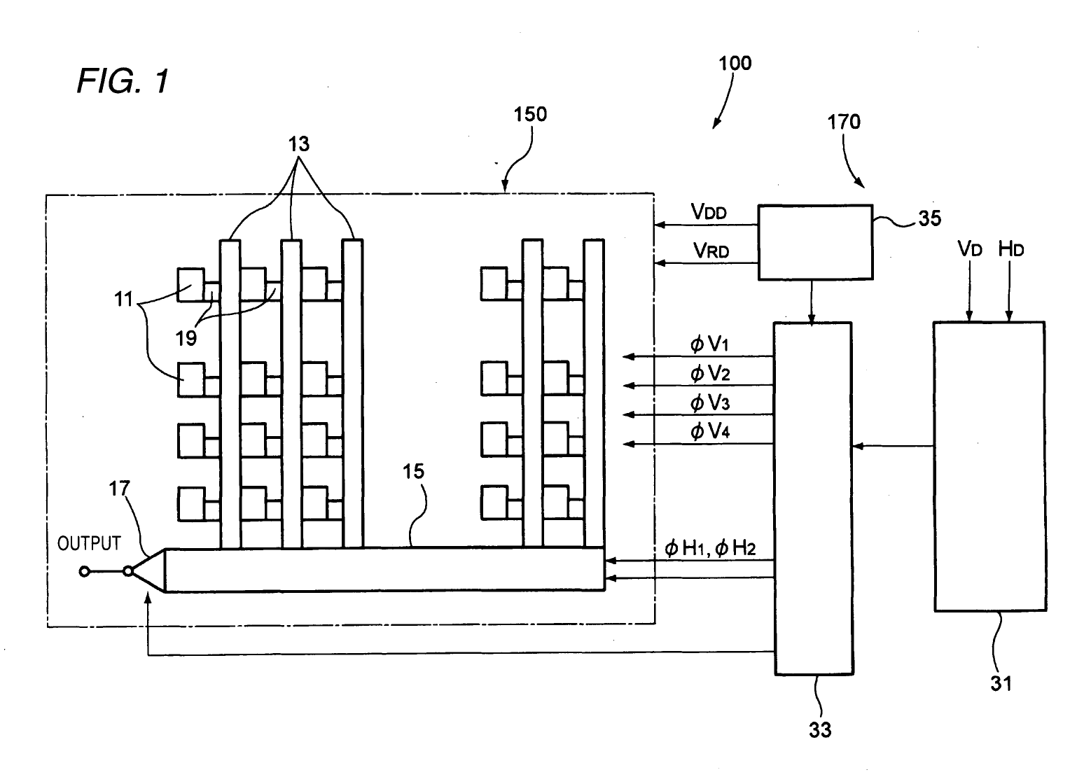

FIG. 1 shows a schematic block diagram of a solid-state imaging device according to an exemplary embodiment of the present invention.

The solid-state imaging device 100 includes a solid-state imaging element 150 such as a CCD and an element driving part 170 for inputting a driving signal to the solid-state imaging element 150. The element driving part 170 includes a timing signal generating part 31 for generating various pulse signals for driving the solid-state imaging element 150 in accordance with a horizontal synchronizing signal HD and a vertical synchronizing signal VD, a driver 33 for changing the various pulses supplied from the timing signal generating part 31 to drive pulses of prescribed levels and supplying the drive pulses to the solid-state imaging element 150 and a driving power source 35 for applying drain voltage VDD and reset drain voltage VRD to the solid-state imaging element 150 to supply prescribed voltage to the driver 33. The solid-state imaging device 100 is driven and controlled in accordance with an output signal from the element driving part 170.

As described above, the solid-state imaging element 150 includes a plurality of photodiodes 11 arranged two-dimensionally, a plurality of rows of vertical shift registers 13 for sequentially transferring signal charges respectively generated in the photodiodes 11 in the vertical direction, a horizontal shift register 15 for transferring the signal charges respectively from the vertical shift registers 13 in the horizontal direction and an output amplifier 17 arranged in an end side in the charge transferring direction of the horizontal shift register 15, converting the transferred signals to voltage values and outputting the converted signals.

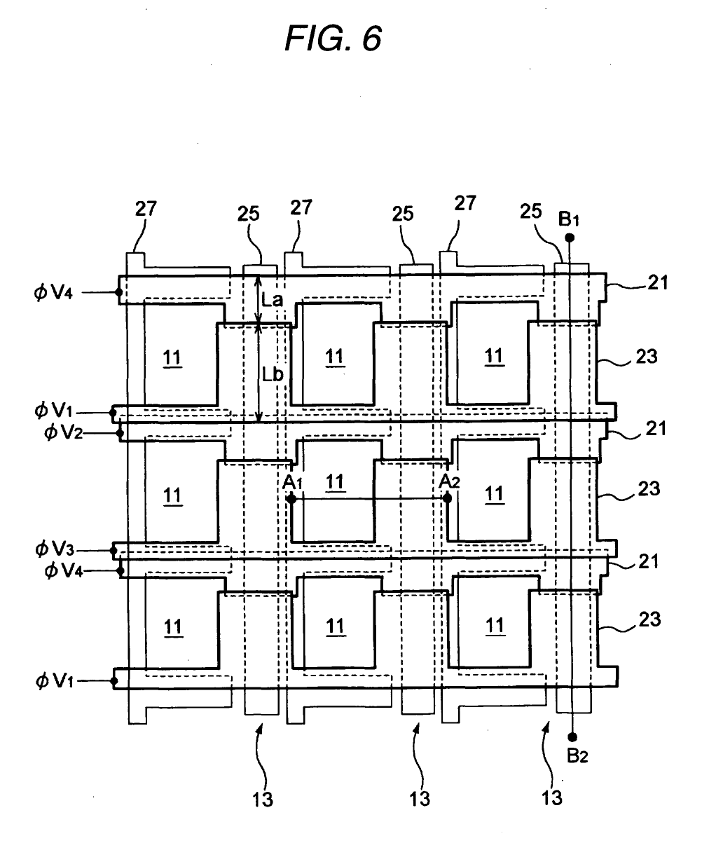

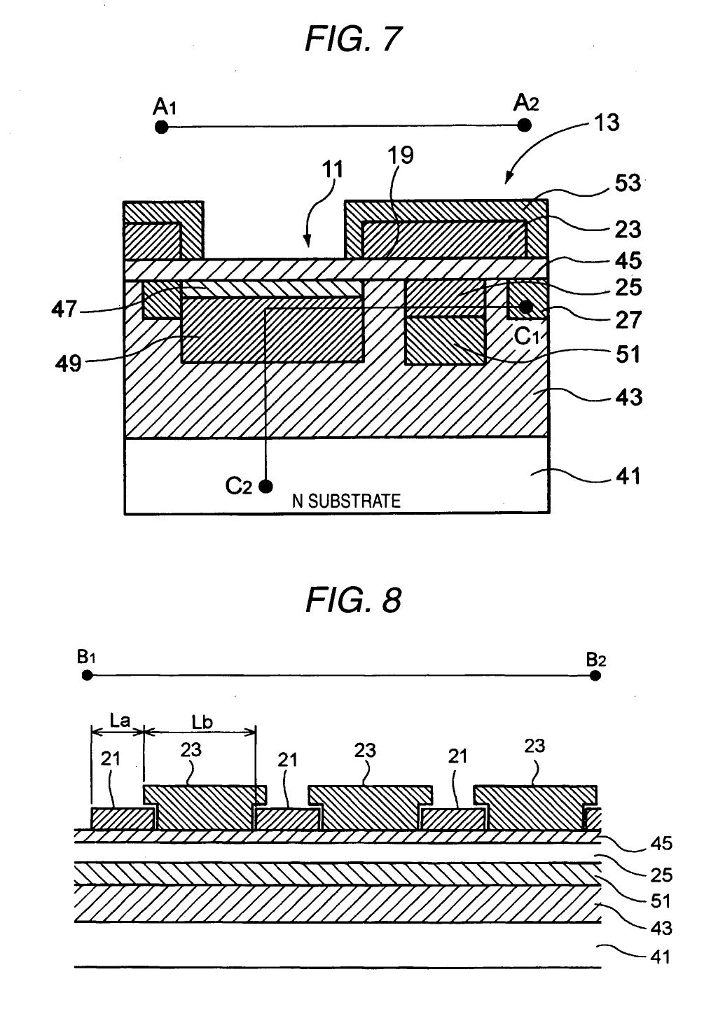

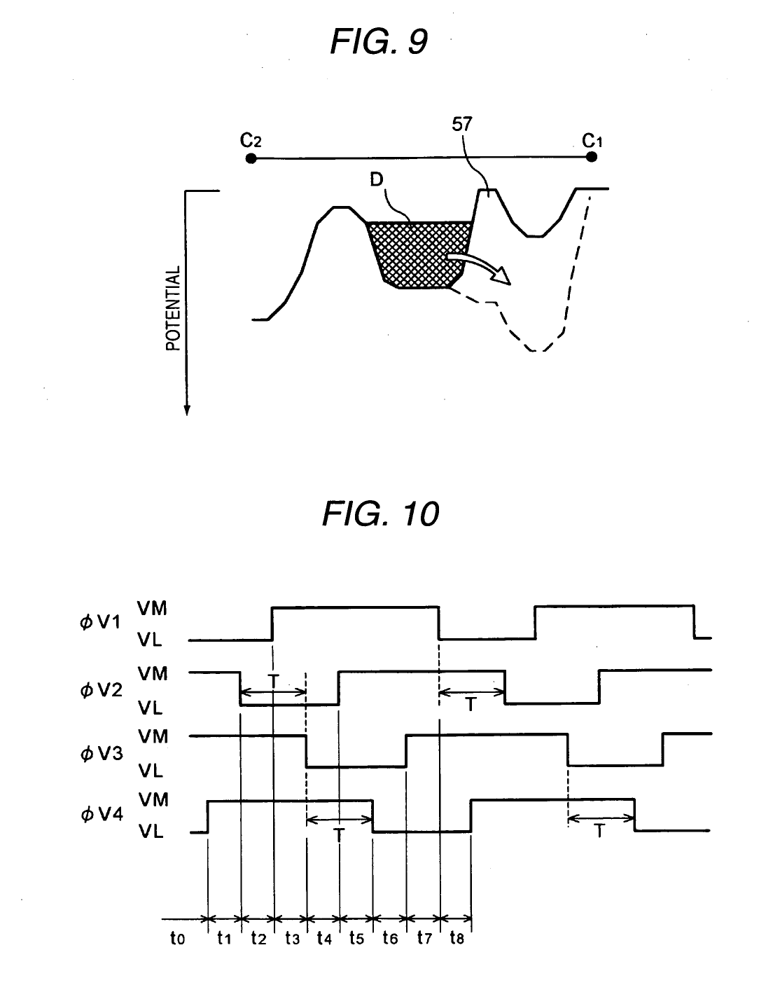

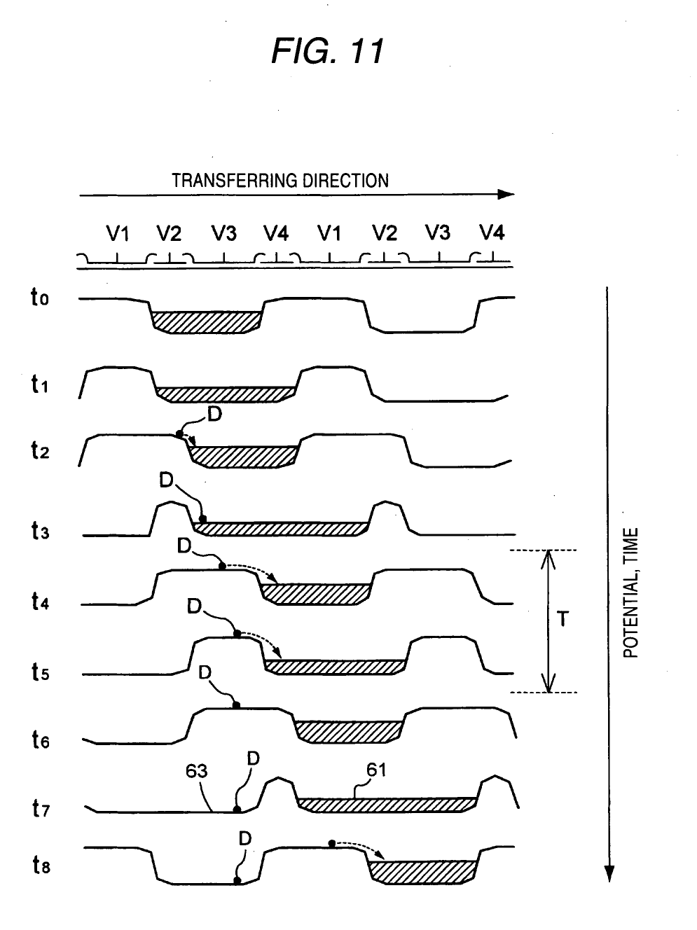

Here, in the vertical electric charge transfer path of the solid-state imaging element 150 of this embodiment, as shown in FIGS. 6 and 8, when the electrode length Lb of a second electrode 23 serving as a reading electrode in the transferring direction of the electric charge is made to be different from the electrode length La of other electrode (a first electrode 21) and the relation between them is expressed by Lb>La.

Then, since the driving timing of the vertical electric charge transfer path is changed, even when the fringing electric field of the adjacent electrode is weakened so that the moving speed of the signal charge is lowered, the influence thereof is hardly received. Further, also eliminated is a problem that since a distance where the signal charge needs to move under the reading electrode is lengthened, it takes more time to move the signal charge under the reading electrode than under other electrode.

Now, the detail of the method for driving the solid-state imaging element according to the present invention will be described below.

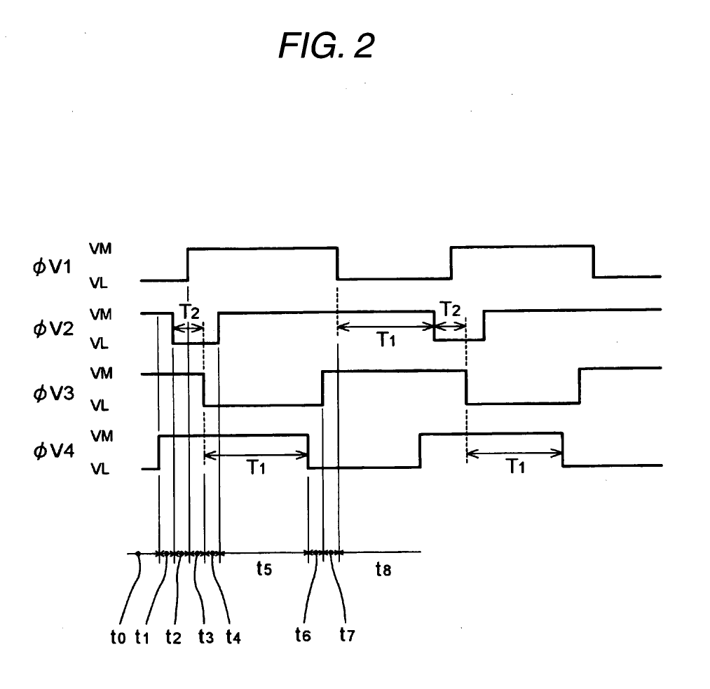

FIG. 2 shows a driving timing chart of the vertical electric charge transfer path. FIG. 2 shows a conceptual diagram of a potential distribution of the transfer path in the section taken along B₁-B₂ in FIG. 6.

Also herein, four types of vertical driving pulses φVI, φV2, φV3 and φV4 are applied to the transfer electrodes (the first electrode 21, the second electrode 23) of the vertical electric charge transfer path from the driver 33 (see FIG. 1) of the element driving part 170 as described above. Herein, the four-phase vertical driving pulses respectively take binary values of a high level (VM) and a low level (VL). The transfer of the signal charged of one line is carried out within a vertical transfer cycle including periods of t1 to t8.

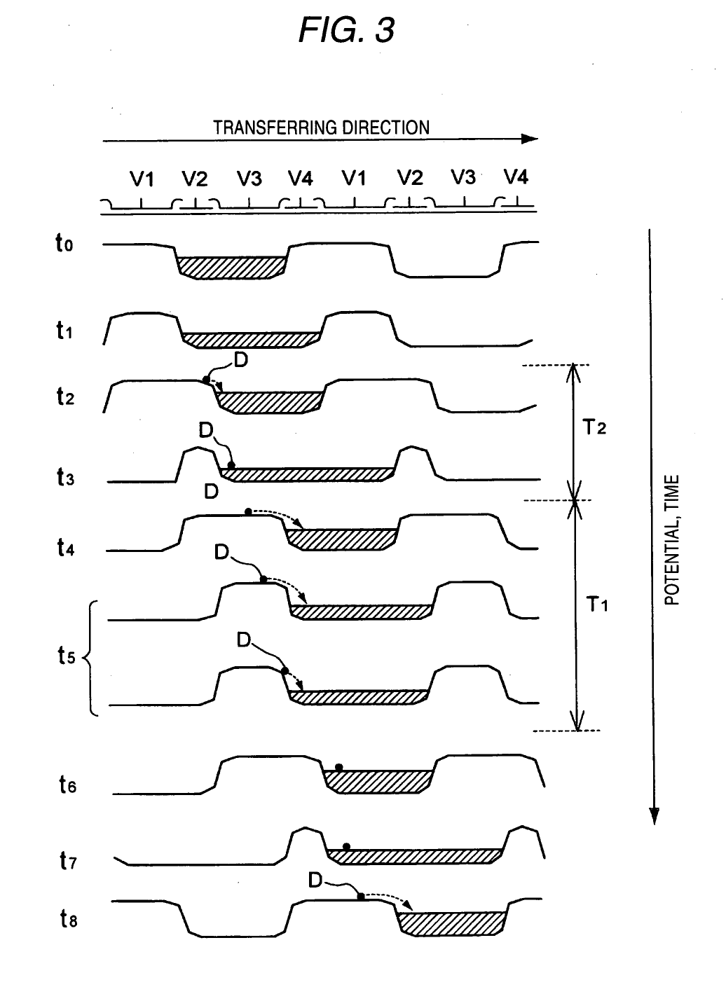

Initially, in a period to before the start of the vertical transferring operation, since φV2 and φV3 are in the high levels (VM), as shown in FIG. 3, a deep potential well is formed under electrodes V2 and V3. Then, the signal charges are accumulated in the potential well and the signal charges shift to the vertical transfer cycle (t1 to t8) under this state.

That is, during the period t1, when φV4 becomes the high level, since the deep potential well extends over electrodes V2, V3 and V4, the signal charges are accumulated under the electrodes V2, V3 and V4.

Then, during the period t2, when φV2 becomes the low level, since the potential well under the electrode V2 is shallow, the signal charges are accumulated under the electrodes V3 and V4. At this time, under the electrode V2, the signal charges D are transferred to the electrodes V3 and V4.

Then, during the period t3, φV1 becomes the high level and the potential well under an electrode V1 is deep. Further, during the period t4, φV3 becomes the low level and the potential well under the electrode V3 is shallow. Thus, a shallow area of the potential well is formed from the electrode V2 to the electrode V3, so that the inclination of the potential is mitigated to lower the moving speed of the signal charges. Thus, it is assumed that a charge transfer time from the period t4 to the period t5 is set to a period T1 so as to ensure the period longer than the usual period T shown in FIG. 10.

Then, during the period t5, φV2 becomes the high level and the shallow area of the potential well is reduced. At this time, since the sufficient charge transfer time T1 is ensured, the signal charges D remaining under the electrode V3 are relatively slowly and assuredly transferred to flow out to the potential well including the lower part of the electrode V4.

Then, during the period t6, when φV4 becomes the low level, the signal charges D are accumulated in a deep area 65 of the potential well under the electrodes V1 and V2. Then, during the period t7, when φV3 is made to become the high level, the signal charges D return to a deep area of the potential well in which the signal charges are to be originally accumulated.

During the period t8, when φV1 is made to become the low level, the same situation as that of the period t4 arises so that the signal charges are repeatedly transferred. As described above, assuming that the period after the driving pulse of the low level is applied to the second electrode 23 serving as the reading electrode until the driving pulse of the low level is applied to the adjacent first electrode 21 is T₁, this period T₁ is set to a sufficiently long period necessary for transferring the electric charges. Thus, the electric charges are prevented from being left. Further, since the period T₁ is set to be longer, a period T₂ from the period t2 to the start of the period t4 is conversely set to be the shorter, so that the transfer of the signal charges is not delayed for all the vertical electric charge transfer path.

Namely, the transferring operation of the signal charges to the vertical electric charge transfer path is carried out in such a way that when the signal charges are transferred from the electrodes whose length is relatively long to the electrodes whose length is relatively short, the charge transfer time is lengthened and when the signal charges are transferred from the electrodes whose length is relatively short to the electrodes whose length is relatively long, the charge transfer time is shortened. Thus, an accurate and stable image can be fetched without leaving the electric charges.

As described above, in the driving method of this embodiment, the period after the driving pulse of the V_{L} level is applied to the second electrode 23 serving as the reading electrode until the driving pulse of the V_{L} level is applied to the adjacent first electrode 21 is set to T₁ as a long period. On the other hand, the relevant period for the first electrode 21 is set to T₂ as a short period. Thus, a time during which the signal charges move under the reading electrode is more lengthened than the usual time so that the complete transfer of the electric charges can be realized. Further, in other electrode, since the electrode length thereof is short, even when the relevant period is shortened, the signal charges can be completely moved.

Therefore, according to the method for driving the solid-state imaging element of the present invention, the signal charges can be completely transferred under the reading electrode. The generation of the deterioration of the image can be assuredly prevented, such as the vertical lines on the screen caused by partly remaining electric charges that have been hitherto generated, and the image of high quality can be obtained in a stable manner.

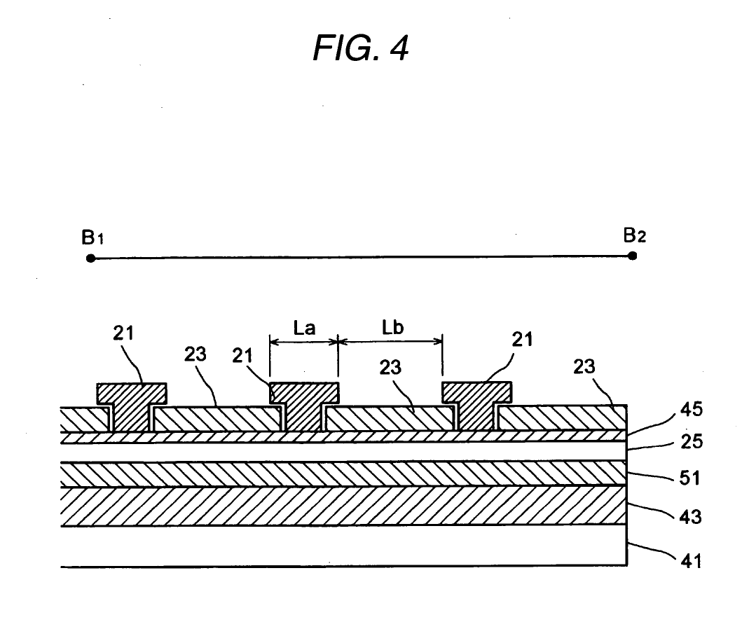

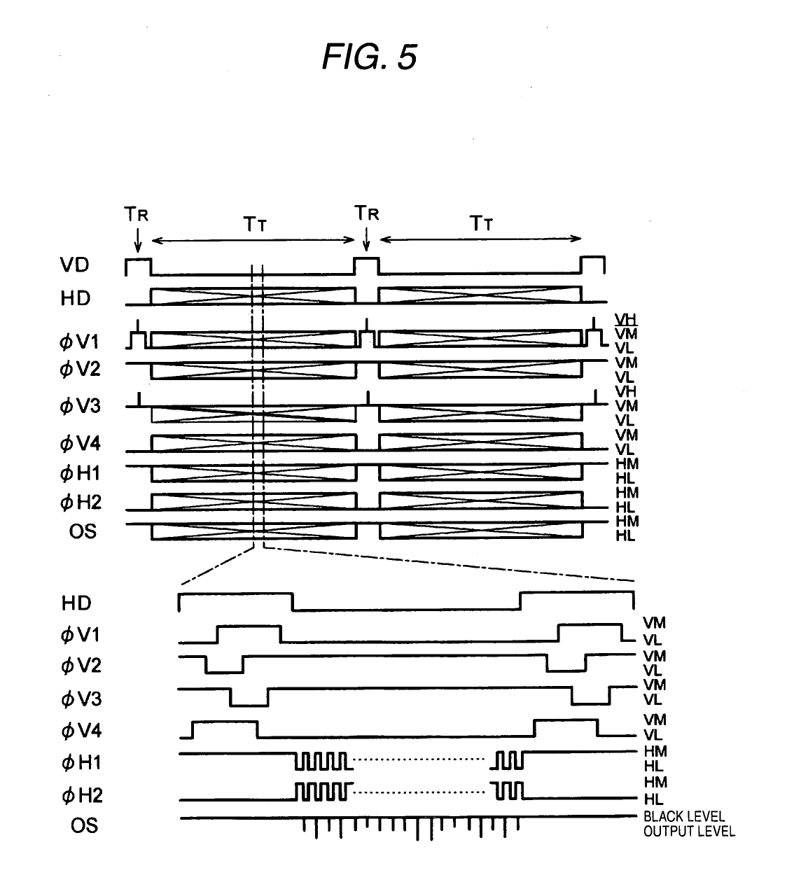

In the structure of the first electrodes 21 and the second electrodes 23 of the vertical electric charge transfer path, protruding parts may be reversed as shown in FIG. 4.

In the above description, the solid-state imaging element 150 has a structure in which the photodiodes 11 are arranged in the horizontal and vertical directions in a square lattice arrangement. However, the present invention may be applied to a structure having what is called a honeycomb arrangement formed by inclining the square lattice arrangement by 45°.

It will be apparent to those skilled in the art that various modifications and variations can be made to the described embodiments of the present invention without departing from the spirit or scope of the invention. Thus, it is intended that the present invention cover all modifications and variations of this consistent with the scope of the appended claims and their equivalents.

This application is based on Japanese Patent Application No. JP2005-145798, filed on May 18, the contents of which is incorporated herein by reference.

What is claimed is:

1. A method for driving a solid-state imaging element,
the solid-state imaging element comprising:
a plurality of photoelectric conversion parts arranged two-dimensionally in a horizontal direction and a vertical direction, each of the photoelectric conversion parts converting incident light to a signal charge;
a plurality of vertical charge-transfer paths, each transferring the signal charge, which is generated in the photoelectric conversion parts, in the vertical direction, wherein each of the vertical charge-transfer paths comprises a plurality of pairs of a first electrode reading out the electric charge from one of the photoelectric conversion parts and a second electrode arranged adjacently to the first electrode along the vertical direction, and the first and second electrodes have different lengths from each other in the vertical direction; and
a horizontal charge-transfer path transferring the signal charge, which is transferred from each of the vertical charge-transfer paths, in the horizontal direction,
the method comprising applying driving pulses to the first and second electrodes to transfer the signal charge, which is read out from the photoelectric conversion parts, in the vertical direction,
wherein the transferring of the signal charge in the vertical charge-transfer paths is performed in such a way that when the signal charge is transferred from one of the first and second electrodes, whose length is relatively long, to the other of the first and second electrodes, a charge transfer time is lengthened, and that when the signal charge is transferred from one of the first and second electrodes, whose length is relatively short, to the other of the first and second electrodes, a charge transfer time is shortened.

2. A solid-state imaging device comprising:
a solid-state imaging element comprising:
a plurality of photoelectric conversion parts arranged two-dimensionally in a horizontal direction and a vertical direction, each of the photoelectric conversion parts converting incident light to a signal charge;
a plurality of vertical charge-transfer paths, each transferring the signal charge, which is generated in the photoelectric conversion parts, in the vertical direction, wherein each of the vertical charge-transfer paths comprises a plurality of pairs of a first electrode reading out the electric charge from one of the photoelectric conversion parts and a second electrode arranged adjacently to the first electrode along the vertical direction, and the first and second electrodes have different lengths from each other in the vertical direction; and
a horizontal charge-transfer path transferring the signal charge, which is transferred from each of the vertical charge-transfer paths, in the horizontal direction, and
an element-driving part driving and controlling the solid-state imaging element in such a way that when the signal charge is transferred from one of the first and second electrodes, whose length is relatively long, to the other of the first and second electrodes, a charge transfer time is lengthened, and that when the signal charge is transferred from one of the first and second electrodes, whose length is relatively shorts to the other of the first and second electrodes, a charge transfer time is shortened.
